(19) United States
(12) Patent Application Publication
(10) Pub. No.: US 2009/0282758 A1
(43) Pub. Date: Nov. 19, 2009

(54) STRUCTURE AND CORNER INTERFACE

(75) Inventor: Erik Lee Skov, Akron, OH (US)

Correspondence Address: MOORE & VAN ALLEN PLLC, P.O. BOX 13706, Research Triangle Park, NC, 27709, US

(73) Assignee: RUBBERMAID, INC., Huntersville, NC (US)

(21) Appl. No.: 12/464,398

(22) Filed: May 12, 2009

Related U.S. Application Data
(60) Provisional application No. 61/127,652, filed on May 14, 2008.

(51) Int. Cl. E06B 1/04; E05D 7/00

(52) U.S. Cl. 52/205; 49/397

(57) ABSTRACT

A structure such as a storage shed, building, cabinet, storage box or the like has a corner structure comprising a wall panel having a wall portion and a corner offset portion that extends at an angle relative to the wall portion to create a corner. The corner offset portion terminates in a protruding edge. A door pivots between a closed position and an open position such that a recess formed in the door panel receives the protruding edge when the door is in the closed position.

This application claims benefit of priority under 35 U.S.C. §119(e) to the filing date of to U.S. Provisional Application No. 61/127,652 as filed on May 14, 2008, which is incorporated herein by reference in its entirety.

### FIELD OF THE INVENTION

The invention relates to structures such as outdoor storage sheds, buildings, cabinets and storage boxes or the like and, more particularly, to an improved interface between the doors and sidewalls of such structures that improve weather resistance and structural integrity.

### BACKGROUND OF THE INVENTION

Outdoor structures such as storage sheds, buildings, cabinets and storage boxes are known that can be assembled on site. Such structures may be made of a variety of materials including wood, metal or molded resin. The structures are typically sold as a kit where the various components may be assembled to create a finished structure. Such structures are known to have shortcomings regarding the weather resistance between the doors and side walls and the structural integrity of the assembled structure.

### SUMMARY OF THE INVENTION

A structure such as a storage shed, building, cabinet, storage box or the like has a corner structure comprising a side wall panel having a side wall portion and a corner offset portion that extends at an angle relative to the side wall portion to create a corner. The corner offset portion terminates in a protruding edge. A door panel pivots between a closed position and an open position such that a recess formed in the door panel receives the protruding edge when the door is in the closed position.

### BRIEF DESCRIPTION OF THE DRAWINGS

FIG. 1 is a front view of an embodiment of a shed constructed in accordance with the invention.

FIG. 2 is a perspective view of the shed of FIG. 1.

FIG. 3 is a section view taken along line 3-3 of FIG. 1.

FIG. 4 is a partial section view taken along line 4-4 of FIG. 1.

FIG. 5 is a partial section view taken along line 5-5 of FIG. 1.

FIG. 6 is a detailed view of the door hinge.

### DETAILED DESCRIPTION OF EMBODIMENTS OF THE INVENTION

In one embodiment the structures made in accordance with the invention are made of a resin material using various molding or forming processes such as blow molding, injection molding or the like. The structure may also be formed of fabricated materials such as wood, composite material or metal rather than molded resin. The structures are provided with an improved interface between the doors and side walls that improve weather resistance and the structural integrity of the assembled structure. The design also improves the strength of the hinge edge of the door in its ability to resist bending, bowing or warping during normal use. The design also maximizes the width of the door opening in the assembled structure.

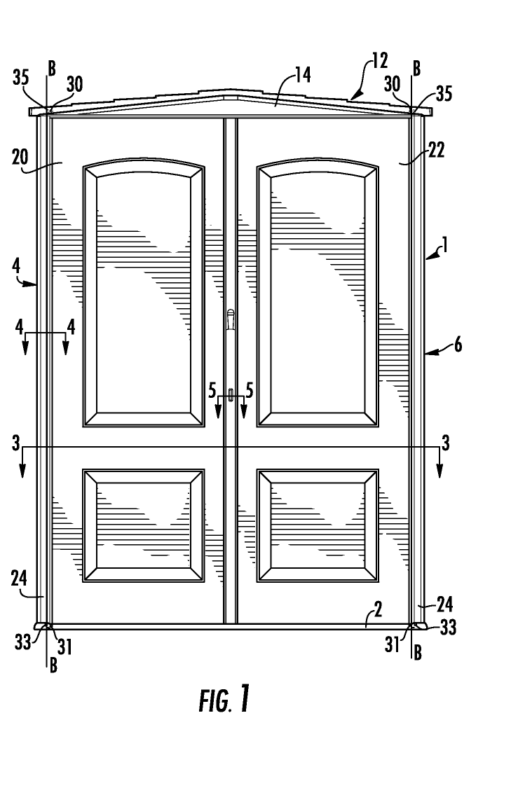

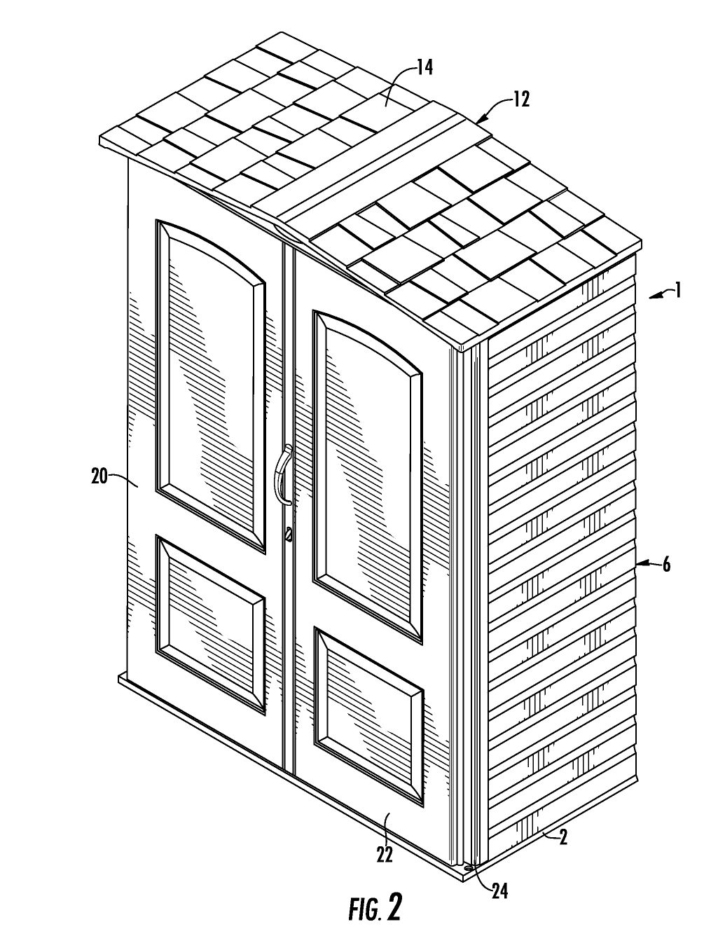

Referring to FIGS. 1, 2 and 3 an outdoor shed 1 is shown illustrating the construction of the invention. While a shed is shown it is to be appreciated that any structure that utilizes a door, such as a building, cabinet, storage boxes or the like, may be made in accordance with the principles of the invention.

Shed 1 comprises a base 2 that supports extending walls 4, 6 and 8 to define an interior space. In one embodiment base 2 forms a substantially horizontal floor with the walls extending substantially vertically therefrom. Each wall may be made of a single-piece, integrally formed panel 5 such as side walls 4 and 6 or the walls may be made of a plurality of panels 7 joined together at joint 10 such as back wall 8. The wall panels are connected to base 2 by any suitable mechanism such as by fasteners such as screws, a snap-fit, interference fit or by a combination of such mechanisms. A roof 12 formed of a roof panel 14 or a plurality of roof panels is supported on the walls. The side walls 4 and 6, back wall 8 and roof 12 are dimensioned to create a structure having a desired depth and height.

At least one door 20 is pivotably supported to create an entry/egress to the interior of the structure. In the illustrated embodiment two such doors 20 and 22 are shown, one pivoted at each of the side walls 4 and 6, such that the doors cooperate to close the space between the side walls 4 and 6.

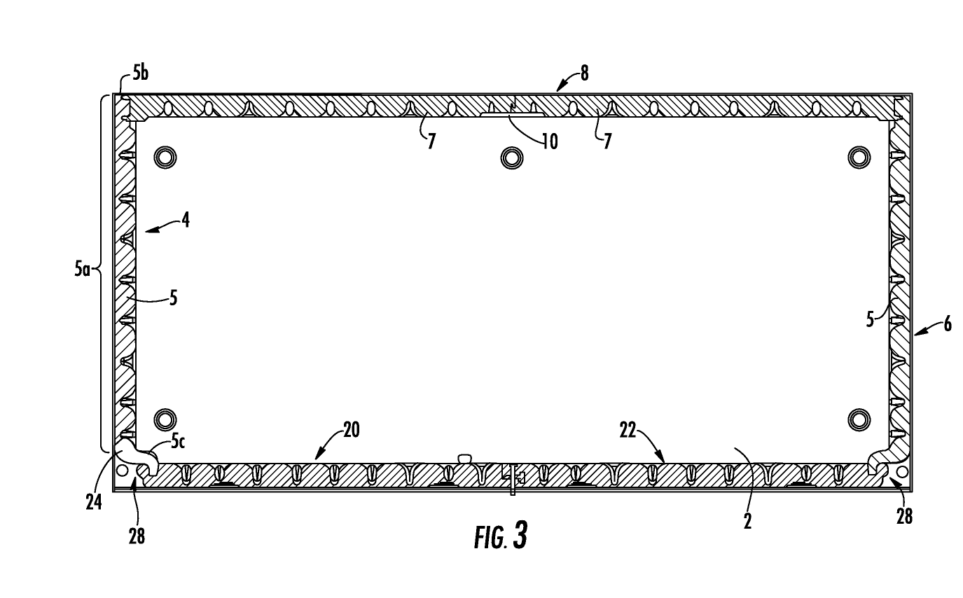

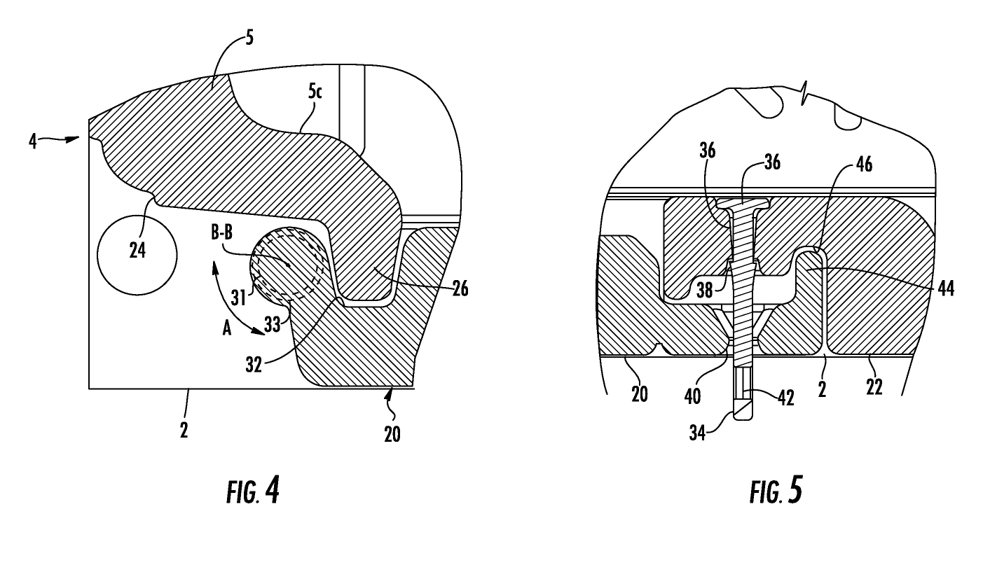

Referring to FIGS. 3 and 4, the section views of shed 1 show the interface of the side wall 4 with the door 20. Door 22 and side wall 6 have the same structure as side wall 4 and door 20 such that specific reference will be made to the arrangement of wall 4 and door 20. Side wall panel 5 includes a wall portion 5a that extends from one end 5b of the panel 5 to a corner offset portion 5c. Corner offset portion 5c extends from the opposite end of wall portion 5a at substantially a right angle relative to wall portion 5a to create a corner 24 that defines a vertical corner of the structure. The corner offset portion 5c terminates in a protrusion edge 26 that extends from the corner offset portion 5c at a substantially right angle such that the protrusion edge 26 is substantially parallel to the wall portion 5a and extends toward the exterior of the structure. The corner offset portion 5c increases the structural stability of the structure by creating portions of the wall panel 5 that extend along two intersecting planes where corner 24 of the assembled structure is created by the unitary, single-piece wall panel 5. The corner offset portion 5c also eliminates the need for metal reinforcement along the hinge edge of the door. The provision of a corner 24 using the integrally formed one-piece side wall panel 5 and offset portion 5c improves the corner rigidity of the structure.

Doors 20 and 22 includes a door hinge 28 that allows the doors to pivot in the direction of arrow A between the closed position shown in FIG. 1 and an open position where the doors are rotated away from the opening between walls 4 and 6. Referring to FIGS. 1, 4 and 6 the door hinge 28 terminates in a top post 30 and bottom post 31 that extend vertically from the door panel 6 at one edge thereof and are axially aligned to create the pivot axis B for the door. The bottom post 31 is received in a hole or socket 33 formed in bottom panel 2 and the top post 30 is received in a hole or socket 35 formed in roof panel 14 such that the door rotates about axis B-B.

Referring to FIGS. 3 and 4, the door 20 includes a door panel recess 32 that closely receives the side wall panel protrusion edge 26 when the door is in the closed position. The recess 32 and protrusion edge 26 are positioned such that they are located inside of and closely adjacent to the hinge axis B and extend parallel thereto. The recess 32 and protrusion 26 are arranged such that the portion of the door defining hinge 28, the protrusion 26 and the remainder of the door are interdigitated. The recess 32 and protrusion edge 26 extend for substantially the height of the door to create a weather tight seal between the door and the side wall panel 4a. The engagement of the protrusion edge 26 and recess 32 creates frictional interference fit that can be increased to create resistance to the door being opened as desired. While FIG. 4 shows a space between protrusion 26 and recess 32 in order to clearly show these components, it is to be understood that the protrusion 26 and recess 32 actually contact one another to create an interference fit as shown in FIG. 3. Door 22 and side wall 6 have the same structure as side wall 4 and door 20.

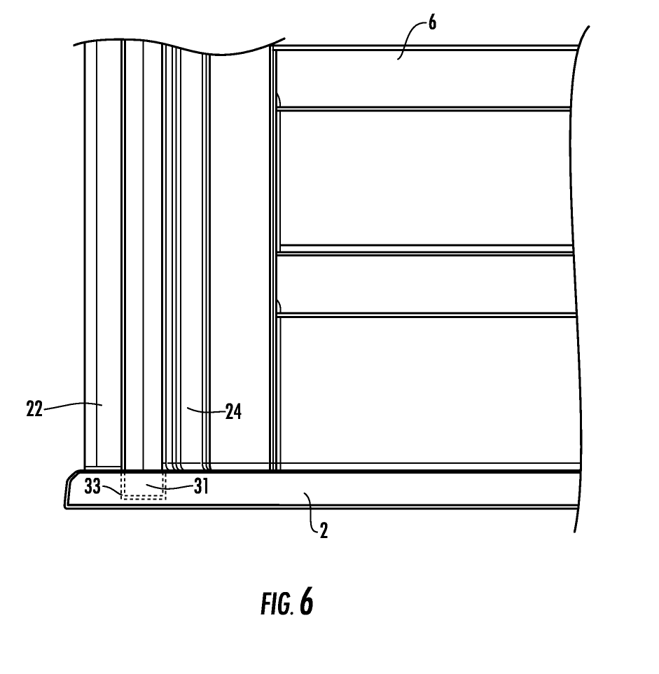

Referring to FIG. 5 a locking mechanism is shown comprising a hasp 34 that is inserted into and retained in a through hole 36 formed in door 22. The hasp 34 traps the door between flange 36 and flange 38. Flange 38 has a tapered profile such that it can be easily inserted into through hole 36 but cannot be removed from the hole 36 due to the engagement of the butt end of flange 38 with the rim of hole 36. The hasp 34 extends through a through hole 40 formed in door 20 where an aperture 42 can be engaged by a lock to lock the doors in the closed position. Door 20 includes a vertical flange 44 that extends into a groove 46 formed in door 22 to create a seal between the doors. If a single door is used, the flange 44 extends into a groove similar to groove 44 formed in the door jamb to create a similar seal between the door and door jamb. The engagement of the flange 44 and groove 46 creates a frictional interference fit.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A corner structure comprising:
a side wall panel comprising a side wall portion and a corner offset portion that extends at an angle relative to the side wall portion to create a corner;
the corner offset portion terminates in a protrusion edge;
a door pivotable between a closed position and an open position;
a recess formed in the door panel that receives the protrusion edge when the door is in the closed position.

2. The structure of claim 1 wherein the wall panel and door are made of a resin material.

3. The structure of claim 1 wherein the wall panel and door are molded.

4. The structure of claim 1 wherein the corner offset portion extends at a substantially right angle relative to the wall panel.

5. The structure of claim 1 wherein the protrusion edge extends from the corner offset portion toward the door.

6. The structure of claim 1 wherein the door includes a door hinge that allows the door to pivot between a closed position and an open position.

7. The structure of claim 6 wherein the door hinge terminates in a top post and bottom post that extend vertically from the door panel adjacent an edge thereof, said top post and said bottom post being axially aligned to create a pivot axis for the door.

8. The structure of claim 7 wherein the bottom post is received in a socket formed in a base panel and the top post is received in a socket formed in a roof panel.

9. The structure of claim 1 wherein the recess closely receives the protrusion edge when the door is closed to create an interference fit between the door and the wall panel.

10. The structure of claim 1 wherein the recess and protrusion edge extend for substantially the height of the door to create a weather tight seal between the door and the wall panel.

11. The structure of claim 7 wherein the recess is located closely adjacent to said pivot axis.

12. A storage structure comprising:
a base panel, at least one wall panel extending from the base panel and a roof panel where said base panel, wall panel and said roof panel are made of a molded resin material;
a door pivotably mounted and movable between an open position and a closed position;
said wall panel comprising a wall portion and a corner offset portion that extends at an angle relative to the wall portion to create a corner, the corner offset portion terminating in a protrusion edge; and
a recess formed in the door that receives the protrusion edge when the door is in the closed position.

13. The storage structure of claim 12 wherein said corner defines an exterior corner of the structure.

14. The storage structure of claim 12 wherein the protrusion edge extends toward the exterior of the structure.

15. The storage structure of claim 12 wherein the door includes a hinge that allows the door to pivot about an axis of rotation.

16. The storage structure of claim 15 wherein the hinge comprises a top post and bottom post that extend from the door panel and are axially aligned along said axis of rotation.

17. The storage structure of claim 16 wherein the bottom post is received in a hole formed in the base panel and the top post is received in a hole formed in the roof panel.

18. The storage structure of claim 12 wherein the recess and protrusion edge extend for substantially the height of the door to create a weather tight seal between the door and the side wall panel.

19. The storage structure of claim 12 wherein the engagement of the protrusion edge and recess creates frictional interference that creates resistance to the door being opened.

20. The storage structure of claim 12 wherein said door includes a vertical flange that extends into a groove formed in a second door to create a seal between said door and said second door.

21. The storage structure of claim 15 wherein the recess is located closely adjacent to said axis of rotation.
